(19) United States
(12) Patent Application Publication
(10) Pub. No.: US 2003/0136650 A1
(43) Pub. Date: Jul. 24, 2003

(54) Two-stage touch switch

(76) Inventor: Che-Yi Lai, Shulin City (TW)

Correspondence Address: RABIN & BERDO, P.C., Suite 500, 1101 14th Street, N.W., Washington, DC, 20005, US

(21) Appl. No.: 10/053,726

(22) Filed: Jan. 24, 2002

(51) Int. Cl. H01H 13/00

(52) U.S. Cl. 200/1 B

(57) ABSTRACT

A two-stage touch switch includes a circuit layer, a base, an elastic member, an insulating film, and a key base sequentially stacked from bottom to top. The key base includes an elastically raised key having a piece of electrically conductive rubber attached to a bottom surface thereof. The elastic member has an outward curved top, and the insulating film stacked on the elastic member has an outward curved area corresponding to the curved top of the elastic member. When the raised key is lightly pushed downward, a first stage of touch occurs; and when the raised key is further pushed, it forces and sinks the curved area of the insulating film and the curved top of the elastic member, and a second stage of touch occurs to complete the two-stage touch.

### FIELD OF THE INVENTION

The present invention relates to a two-stage touch switch, and more particularly to a touch switch in which a first stage of touch occurs when an elastically raised key of the switch is lightly depressed, and a second stage of touch occurs when the key is further depressed. The two-stage touch switch includes stacked thin layers and therefore enables a low profile having largely reduced overall thickness.

### BACKGROUND OF THE INVENTION

Generally, a multi-stage touch switch may be employed in a shutter release button of a camera, keys on a mobile phone, keys on a keyboard, etc., so that each key may be designed to provide multiple functions through touch of only one single key.

Taiwanese Patent Application No. 89221927 discloses a stagewise touch switch for keyboard. The switch includes a base, a first element, a second element, and a key head. The first and the second elements are movably connected to each other by way of staggered joint, and then movably connected to a shaft hole and a retaining slot, respectively, provided on the base in order to support the key head on their tops. The first element includes a horizontal seat, an end of which has a first extension arm that is pointed toward a central shaft hole and has a flange formed at a bottom of a front end thereof. The second element defines a framed space and has a second extension arm provided at an inner side corresponding to a central shaft. The second extension arm includes a tapered end to serve as a journal and correspond to the flange provided on the first extension arm of the first element. When the key head is depressed, the flange and the tapered end frictionally contact with and push against each other to provide a stagewise touch of the key.

Since the first and the second elements have a frame structure and are movably connected to each other by way of staggered joint, they would usually result in increased overall dimensions of the key, preventing the key from miniaturization. Moreover, the flange and the tapered end tend to wear after they frictionally contact with each other over a long time, resulting in failure of the stagewise touch. The conventional shutter release button for camera is normally a multi-stage touch switch. However, such conventional multi-stage touch switch, due to limitations in its structural design, would normally have an obviously protruded button. That is, the button has a considerably large thickness.

It is therefore tried by the inventor to develop a two-stage touch switch that includes multiple stacked thin layers to provide a low-profile switch having largely reduced overall thickness.

### SUMMARY OF THE INVENTION

The present invention provides a two-stage touch switch including a circuit layer, a base, an elastic member, an insulating film, and a key base stacked from bottom to top. The key base includes an elastically raised key having a piece of electrically,conductive rubber attached to a bottom of the key. The elastic member has an outward curved top, and the insulating film stacked on the elastic member also includes an outward curved area corresponding to the curved top of the elastic member. When the elastically raised key is initially depressed, a first stage of touch occurs. When the key is further depressed, it forces the curved area of the insulating film and the curved top of the elastic member to sink and a second stage of touch occurs. A user needs to push only one single key to obtain a two-stage touch. All the circuit layer, the base, the insulating film, and the elastic member are thin layers stacked one by one, allowing the entire two-stage touch switch to have a low profile, that is, a largely reduced overall thickness, and therefore particularly suit for use on cameras, mobile phones and the like that provide functions via keys. With the two-stage touch switch of the present invention, a user needs to push one single key to obtain more than one function.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded and sectioned side view of a two-stage touch switch according to the present invention;

FIG. 2 is an assembled and sectioned side view of FIG. 1;

FIGS. 2A and 2B are enlarged top views of circuits provided on a circuit layer and an insulating film, respectively, of the two-stage touch switch of the present invention; and

FIGS. 3 through 6 shows continuous movements of pushing the two-stage touch switch of the present invention.

### DETAILED DESCRIPTION OF THE PREFERRED EMBODIMENTS

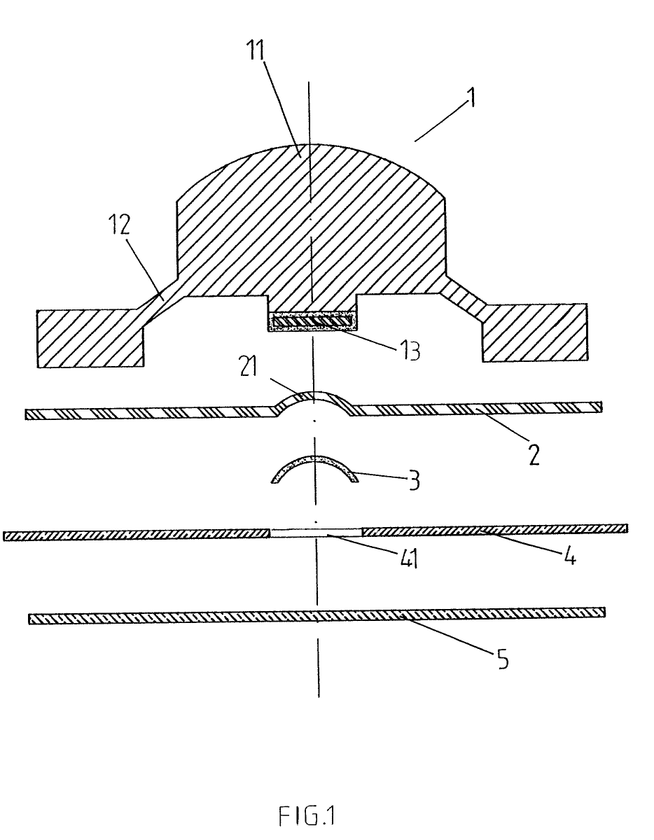

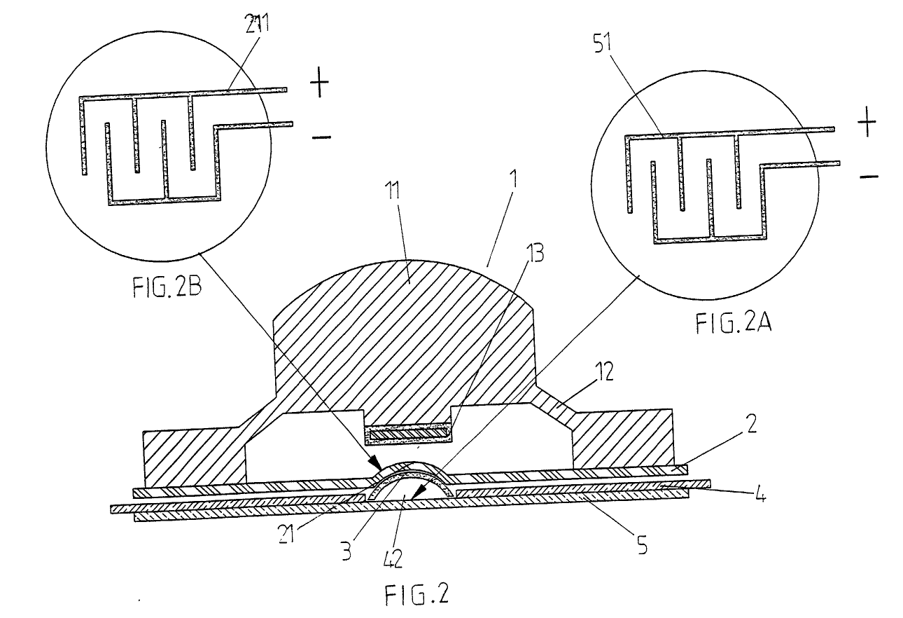

Please refer to FIGS. 1 and 2 that are exploded and assembled sectioned side views, respectively, of a two-stage touch switch according to the present invention. As shown, the two-stage touch switch mainly includes a circuit layer 5, a base 4, an elastic member 3, an electrically insulating film 2, and a key base 1 sequentially stacked from bottom to top.

The circuit layer 5 may be made of a hard card or board or a soft film, on an upper surface of which there is printed or etched a first circuit 51 with lead-out positive and negative electrodes, as shown in FIG. 2A, to form a printed circuit board (PCB) or a film-type printed circuit board (FPCB). The base 4 is provided at a predetermined position with a through hole 41, which forms a cavity 42 when the base 4 is stacked on the circuit layer 5 and is aligned with the first circuit 51 printed or etched on the circuit layer 5.

The elastic member 3 is made of a metal material providing an appropriate elasticity and has an outward curved top. The elastic member 3 is dimensioned to fitly locate in the cavity 42 with the curved top projected beyond the cavity 42.

The electrically insulating film 2 is stacked on the base 4 and is a thin sheet made of a plastic material. A portion of the insulating film 2 corresponding to the curved top of the elastic metal member 3 is formed of an outward curved area 21. When the insulating film 2 is stacked over the base 4, a lower surface of the curved area 21 tightly bears against and covers an upper surface of the curved top of the elastic member 3. An upper surface of the curved area 21 of the insulating film 2 is provided with a second circuit 211 having lead-out positive and negative electrodes, as shown in FIG. 2B.

The key base 1 stacked on the insulating film 2 is made of a synthetic rubber material. A portion of the key base 1 corresponding to an area surrounding the curved area 21 of the insulating film 2 forms a raised key 11, a bottom of which has a piece of electrically conductive rubber 13 attached thereto. The key 11 is provided along a bottom periphery with a downward and outward inclined elastic skirt portion 12, so that the key 11 is elastically supported on the skirt portion 12 to indirectly connect to and raise from the key base 1, and an internal space is formed between the bottom of the raised key 11 and the insulating film 2.

The main purpose to provide the base 4 is to avoid the possibility of even a very small amount of air in a clearance between the insulating film 2 and the circuit layer 5 to prevent the key 11 from functioning as a two-stage touch switch, and to prevent production of any spark during touch of the key 11. It is understood that the base 4 may also be omitted without causing any significant influence on the operating effect of the entire two-stage touch switch of the present invention.

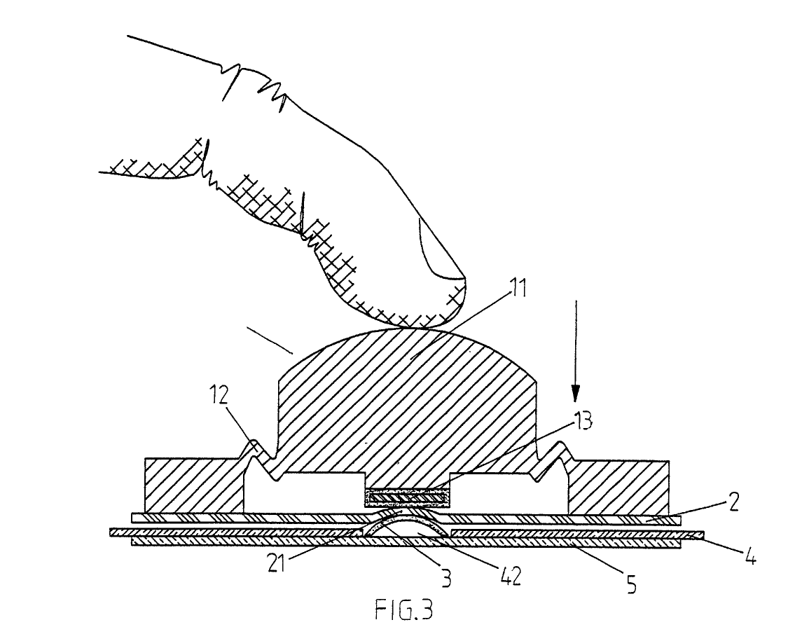

Please refer to FIG. 3. When the key 11 is downward pushed, the skirt portion 12 made of synthetic rubber material having proper elasticity and toughness is caused to bend and elastically deform, bringing the key 11 to sink and provide the first stage of touch. At this point, the electrically conductive rubber 13 is forced downward to touch the second circuit 211 etched on the curved area 21 of the insulating film 2 to electrically connect the positive electrode to the negative electrode of the second circuit 211. The electric connection of the two electrodes on the second circuit 211 is defined as one functional operation of the two-stage touch switch of the present invention.

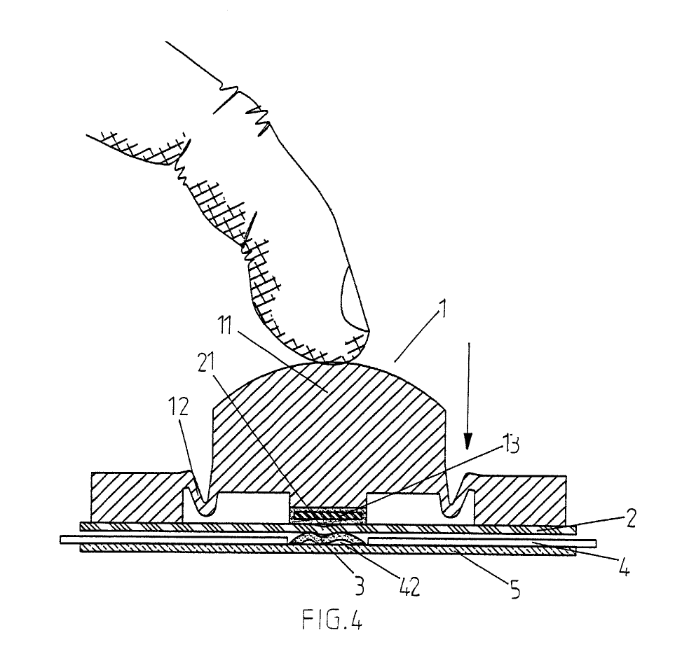

Please refer to FIG. 4. When a push force is continuously applied on the key 11 after the first push, the electrically conductive rubber 13 initially touching the second circuit 211 is now completely pressed against the second circuit 211, instantaneously flattening the curved area 21 of the insulating film 2 and causing the curved top of the elastic metal member 3 to sink and deform. At the instant of deformation of the elastic metal member 3, the second stage of touch occurs to electrically connect the positive electrode to the negative electrode of the first circuit 51 on the elastic metal member 3. The electric connection of the two electrodes on the first circuit 51 is defined as another functional operation of the two-stage touch switch of the present invention.

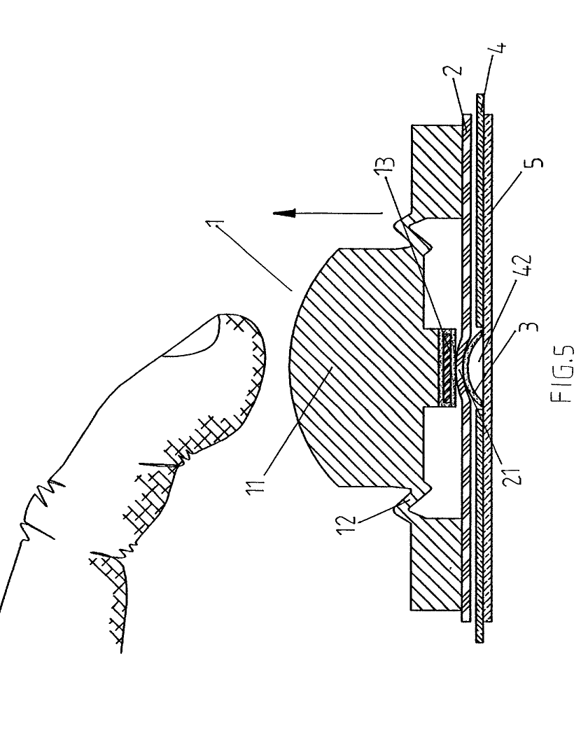

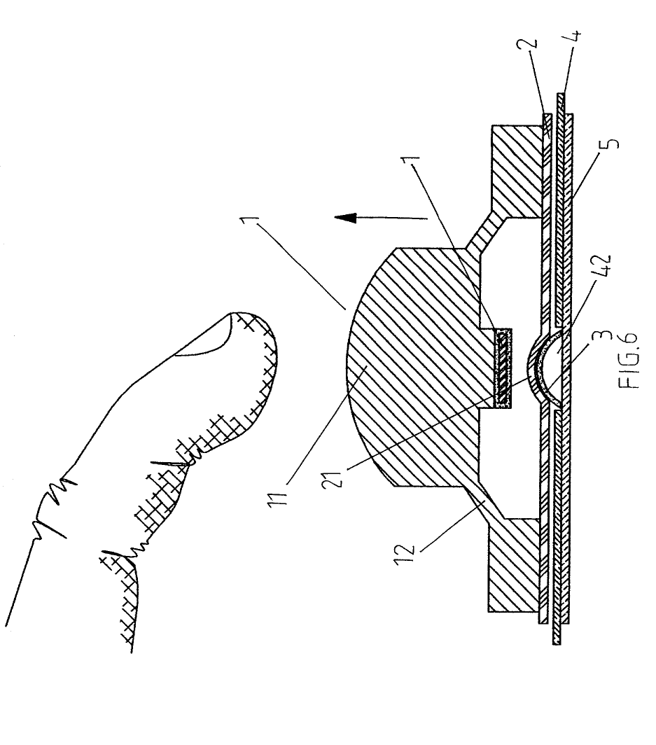

Please refer to FIG. 5. When the push force is released from the key 11, the proper elasticity of the elastic metal member 3 quickly springs the latter to the original outward curved shape and restores the curved area 21 of the insulating film 2. Meanwhile, the previously elastically deformed skirt portion 12 also returns to the original raised position due to its elastic restoring force.

The circuit layer 5, the base 4, the elastic metal member 3, the insulating film 2, and the key base 1 forming the switch of the present invention all are thin layers sequentially stacked from bottom to top, they not only enable the switch to provide the two-stage touch but also allow the switch to have a low profile, that is, to have a largely reduced overall thickness. The two-stage touch switch of the present invention is therefore particularly suitable for cameras, mobile phones and the like that are preferably designed to have a key structure enabling more than one function through touch of only one single key. For example, when the two-stage touch switch of the present invention is employed as the key of a mobile phone, it may be designed for the first stage of touch of the key to electrically connect the second circuit to provide one type of function option, and the second stage of touch of the key through further push of the key to electrically connect the first circuit to provide another type of function option. A user needs to touch only one single key to achieve more than one function.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A two-stage touch switch, comprising a circuit layer having a first circuit etched thereon, an elastic metal member having an outward curved top and positioned on said circuit layer, and a key base stacked on said circuit layer to locate above said elastic metal member; and a portion of said key base corresponding to said elastic metal member being elastically raised from said key base to form a key;
whereby when said elastically raised key is initially pushed downward, a first stage of touch occurs; and when said elastically raised key is further pushed downward, a second stage of touch occurs for a bottom of said key to contact with and sink said outward curved top of said elastic metal member, and thereby make said first circuit on said circuit layer.

2. The two-stage touch switch as claimed in claim 1, wherein said elastic metal member has an electrically insulating film attached to an upper surface thereof, said insulating film being provided at an upper surface with a second etched circuit; and wherein said elastically raised key is provided at the bottom with apiece of electrically conductive rubber, which is forced against said second circuit on the upper surface of said insulating film during said first stage of touch and thereby makes said second circuit.

3. The two-stage touch switch as claimed in claim 1, wherein said elastically raised key is provided along a lower periphery with a downward and outward inclined elastic skirt portion, and said elastically raised key is indirectly connected to said key base via said skirt portion.

4. The two-stage touch switch as claimed in claim 2, wherein said elastically raised key is provided along a lower periphery with a downward and outward inclined elastic skirt portion, and said elastically raised key is indirectly connected to said key base via said skirt portion.

5. The two-stage touch switch as claimed in claim 2, further comprises abase stacked on said circuit layer; said base being provided with a through hole, in which said elastic metal member is positioned with said outward curved top thereof projected therefrom; whereby existence of any air in a clearance between said insulating film and said circuit layer is avoided to ensure occurrence of said first and said second stage of touch and to prevent production of any spark during said two stages of touch.

6. The two-stage touch switch as claimed in claim 1, wherein said circuit layer is a printed circuit board (PCB), including a film-type printed circuit board (FPCB).
